(19) United States
(12) Patent Application Publication
(10) Pub. No.: US 2007/0012789 A1
(43) Pub. Date: Jan. 18, 2007

(54) System and method for indicating validity of calibration certifications

(75) Inventors: Nicholas A. Hartney, St. Petersburg, FL (US); Winston S. Webb, Key Largo, FL (US); David R. Vella, Palm Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/182,376

(22) Filed: Jul. 15, 2005

(51) Int. Cl. G06K 19/06; G06K 7/10; G06K 19/00

(52) U.S. Cl. 235/492; 235/487; 235/462.01

(57) ABSTRACT

An improved system and method for automatically indicating the validity of calibration certifications is disclosed. For one example, a self-terminating calibration certification system is disclosed as a label with a first layer including a thermally-activated material with a bar code printed on one side, a heater element on the second side of the first layer, and a second layer of material affixed to the second side. A processing unit, a power unit, and a transmitter/receiver unit are affixed to one side of the second layer, and an adhesive material is affixed to the second side of the second layer. Thus, the label can be affixed semi-permanently to the measurement instrument or item of test equipment involved. When the measurement instrument or item of test equipment is calibrated, the processing unit starts an internal clock that counts down (or up) to the calibration certification due date. On that date when the calibration certification expires, the processing unit activates the heater element, and the heat generated by the heater element reacts with the thermally-activated material and changes the color of a significant portion of the bar code region. Consequently, after the calibration certification for that measurement instrument or item of test equipment has expired, the bar code on the certification label cannot be scanned in and is no longer visibly readable. Therefore, a user can readily observe from the color of the certification label that the certification for that measurement instrument or item of test equipment is either valid or invalid. Also, invalid bar code information on the label cannot be inadvertently scanned in.

### FIELD OF THE INVENTION

The present invention relates generally to the field of test equipment calibration and certification, and more specifically, but not exclusively, to a system and method for automatically indicating the validity of test equipment calibration certifications. More precisely, the invention relates to a system and method for automatically indicating and terminating expired calibration certifications.

### BACKGROUND OF THE INVENTION

Calibration is the determination, by measurement or comparison with an established reference or standard, of the correct value of each reading on a measurement instrument or item of test equipment. The reference or standard may be maintained by a national or international organization. In the United States, the primary calibration standards are maintained by the National Institute of Standards and Technology (NIST). Typically, detailed records are maintained for each instrument that is calibrated to ensure traceability back to the standard(s) involved, and to document that the instrument has met clearly identified specifications for both accuracy and precision in all of its operating parameters. Calibration is a very important quality assurance procedure, because a measurement instrument that is out of calibration can produce inaccurate and imprecise readings. Consequently, if an incorrect test reading is given for a product, then the tested product is likely to fail (e.g., structurally and/or operationally).

Certification is a procedure by which a party provides written assurance that a product, process or service conforms to specific requirements. A certification of calibration is a document that can include one or more NIST trace numbers, date of calibration, recalibration due date (date when the certification expires), and other information pertinent to the calibration of the measurement instrument or item of test equipment involved (e.g., make and model number, serial number, adherence to federal or military standards, etc.). A calibration certification may be signed by a certified inspector and witnessed by a notary public. However, a typical and simpler calibration certificate used to identify a calibrated instrument or item of test equipment is a calibration label, which can be affixed to the instrument or item of test equipment involved. The pertinent calibration information for that instrument or item of test equipment is printed in a readable format on the front or visible portion of the label.

A significant calibration problem that occurs is that users of calibrated instruments or test equipment often misread or overlook the pertinent calibration information (e.g., date of calibration, recalibration due date, certification due date, etc.) printed on the labels affixed to the instruments or test equipment involved. This problem typically arises when a test measurement is performed or during the process of creating an equipment list (list of measurement instruments or test equipment to be used for a specific test). Consequently, if a test is performed on a product with an instrument that is out of calibration, then the test results for that product are invalid. Therefore, the manufacturer of that product may incur a significant additional expense, by either having to repeat the test or somehow verify, to the customer's satisfaction, that the product can still operate within specification. This problem is compounded by the fact that even if the instruments or test equipment are calibrated, clerical mistakes can be made while the equipment lists are being filled out. Consequently, calibration information on an equipment list can be wrong, which invalidates the calibration certification for the instruments or test equipment involved. Furthermore, the process of filling out an equipment list is time consuming and tedious, and results in excessive test cycle times. Also, equipment lists are not readily converted to digital form, so users typically have to maintain hard copies of equipment lists until they are no longer deemed to be needed. Therefore, it would be advantageous to have a system and method that simplifies the process of creating equipment lists, reduces errors with respect to recognizing invalid calibration certifications, and reduces the costs (in terms of time and money) for the testing process. As described in detail below, the present invention provides such a system and method, which resolves the equipment list and other calibration problems encountered with existing techniques.

### SUMMARY OF THE INVENTION

The present invention provides an improved system and method for automatically indicating the validity of calibration certifications. In accordance with a preferred embodiment of the present invention, a self-terminating calibration certification system is provided as a label with a first layer including a thermally-activated material with a bar code printed on one side, a heater element arranged on the second side of the first layer, and a second layer of material affixed to the second side of the first layer. A processing unit, a power unit, and a transmitter/receiver unit are affixed to one side of the second layer, and an adhesive material is affixed to the second side. Thus, the label can be affixed semi-permanently to the measurement instrument or item of test equipment involved. When the measurement instrument or item of test equipment is calibrated, the processing unit starts an internal clock that counts down or up to the calibration certification due date. On the date when the calibration certification expires, the processing unit activates the heater element, and the heat generated by the heater element reacts with the thermally-activated material and changes the color of a significant portion of the bar code region. Consequently, after the calibration certification for that measurement instrument or item of test equipment has expired, the bar code on the certification label cannot be scanned in and is no longer readable. Therefore, in accordance with an important principle of the present invention, a user can readily observe from the color of the certification label that the certification for that measurement instrument or item of test equipment is either valid or invalid. Also, invalid bar code information on the label cannot be inadvertently scanned in.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a self-terminating calibration certification system, which can be used to implement a preferred embodiment of the present invention; and

FIG. 2 depicts an example of an expired self-terminating certification system, which illustrates an embodiment of the present invention.

### DETAILED DESCRIPTION OF PREFERRED EMBODIMENT

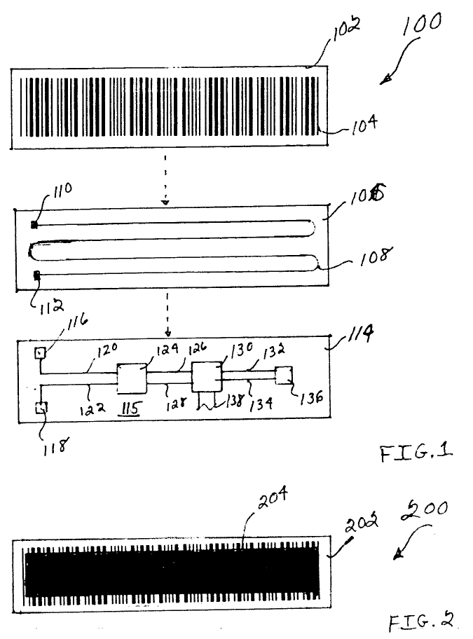

With reference now to the figures, FIG. 1 depicts a self-terminating calibration certification system 100, which can be used to implement a preferred embodiment of the present invention. For this example embodiment, system 100 is implemented in part as a calibration certification label, and in particular, a bar code type of certification label. However, it should be understood that the present invention is not intended to be so limited and can include within its scope any suitable medium that can be used to affix pertinent calibration and/or certification information to a particular instrument or item of test equipment in any suitable format (e.g., text, bar code, encoded text, alphanumeric code, magnetic code, etc.). Preferably, the medium used enables a user to have the calibration and/or certification information contained in the medium automatically or manually scanned in or otherwise recorded. For example, the calibration and/or certification information stored on (or in) the medium can be scanned with an optical or magnetic type reader device to retrieve that information. The calibration and/or certification information can include, for example, the model number and serial number of the measurement instrument or item of test equipment involved, the due date when the calibration certification expires (or the recalibration due date), and/or other pertinent calibration certification information as desired. Thus, for example, the calibration/certification information for that measurement instrument or item of test equipment can be scanned in and used to create an equipment list.

For this example embodiment, system 100 includes a layer 102 of a thermally-sensitive material. In other words, layer 102 is composed of a chemically treated material that can react to a change in temperature with a change in color. For this example, layer 102 is a thin, rectangular layer of a chemically treated, white paper material that reacts to a localized increase in temperature by darkening in color (e.g., turning black, red, green, etc.). In other words, layer 102 can change its color state in response to a localized increase in temperature. Also, for this example, one side of layer 102 is imprinted with pertinent calibration and/or certification information 104 in a bar code format. Again, although a bar code format is shown in FIG. 1 for this example embodiment, the calibration and/or certification information 104 on (or in) layer 102 can be imprinted (or stored) in any suitable format (e.g., text, encoded text, alphanumeric code, magnetic code, etc.) on (or in) layer 102.

The second side of layer 102 (e.g., identified as item 106) includes a heating unit 108. For this example embodiment, heating unit 108 is composed of a single heating wire (e.g., Nichrome®) embedded in (or disposed on) side 106 and suitably arranged to cover a substantial portion of side 106. Also, for this example, a respective electrical contact 110, 112 is connected to each end of heating unit 108. Thus, an electrical current (e.g., DC, AC, digital pulse, etc.) can be applied via contacts 110 and 112 to activate heating unit 108. Heating unit 108 is arranged in close proximity to layer 102, and when heating unit 108 is activated, the heat generated by heating unit 108 causes layer 102 to change its color state (e.g., turn black).

System 100 also includes a second layer 114 of a suitable material. For example, layer 114 can be composed of a thin layer of a suitable rectangular-shaped material (e.g., polymer, plastic, paper, etc.). For this example embodiment, system 100 also includes a microcircuit (indicated generally as item 115) embedded in or otherwise attached to one side of layer 114. For example, microcircuit 115 can be implemented with thin film technology or suitable discrete electronic components. This side of layer 114 shown in FIG. 1 is arranged adjacent to side 106 of layer 102. The microcircuit includes a plurality of circuit components, such as, for example, a pair of contacts 116, 118 that each mate and make electrical connection with a respective contact 112, 110, a pair of electrical conductors 120, 122 coupled to respective contacts 116, 118 and two output connections of a processing unit 124, a pair of electrical conductors 126, 128 coupled to two input connections of processing unit 124 and two input connections of a power unit (e.g., battery) 130, and a pair of electrical conductors 132, 134 coupled to two output connections of power unit 130 and two connections of transmitter and receiver unit 136. For this example embodiment, transmitter and receiver unit 136 is a transmitter/receiver device capable of operating in a suitable Radio Frequency (RF) band. A small heating filament 138 is also coupled to two output connections of power unit 130. Also, for this example embodiment, an adhesive material is applied to the second side of layer 114 (not shown) so that the second side of layer 114 (and system 100) can be affixed (e.g., stuck) to the measurement instrument or item of test equipment involved.

Thus, for this example embodiment, system 100 forms a self-terminating calibration certification bar code label for a particular measurement instrument or item of test equipment. The first side of layer 114 (shown in FIG. 1) is arranged adjacent to side 106 of first layer 102. One side of the composite label (e.g., system 100) displays printed bar code 104, and an adhesive material is disposed on the opposite side of the label (side not shown). A substantial portion of the label, except for the bar code, may be encased in a suitable material (e.g., plastic, polymer, paper, etc.). Therefore, the label (system 100) can be affixed semi-permanently to the particular calibrated instrument or item of test equipment involved.

In operation, for this example embodiment, the bar code (text, code, etc.) 104 can be imprinted on the label (system 100) with a suitable printer that accepts the size and shape of the label. The printer is connected to a computer processor. When the instrument or item of test equipment of interest is calibrated, an operator can enter the pertinent calibration information to the computer processor (e.g., via a keyboard, etc.). For example, the operator may enter the make and model of the calibrated instrument, its serial number, the certification due date (i.e., date when the calibration certification expires), and any other relevant calibration or certification information desired. The computer processor executes a suitable algorithm (e.g., implemented in software) that causes the printer to print the pertinent calibration information on layer 102 in bar code form. Also, at this point, given the known certification due date, the computer processor can execute a suitable algorithm to determine the certification self-termination time interval (e.g., counting down or up), and initiate a process to transmit that time interval data (e.g., via a suitable RF transmitter associated with the printer) in digital (or analog) form to processing unit 124 (e.g., via the receiver portion of transmitter/receiver unit 136). Alternatively, in another embodiment, each label (system 100) may be manufactured with a predetermined self-termination time interval built in (e.g., three months, six months, one year, etc.).

For this example embodiment, the microcircuit of system 100 includes a miniature contact switch (not shown in FIG. 1) that is electrically connected to processing unit 124 and accessible to an operator at a surface of the label. The operator can press this switch (e.g., by squeezing an appropriate portion of the label), which causes processing unit 124 to start the countdown (or count up) of the certification self-termination clock. Also, processing unit 124 causes power unit 130 to output a current to heating filament 138, which in turn causes a slight discoloration of a small region of the thermally-sensitive material of layer 102. This slight discoloration of a small region of layer 102 indicates to the operator (and to a subsequent user) that the certification self-termination clock countdown (or count up) of system 100 has been started. The operator can then affix the certification self-termination label (system 100) to the calibrated instrument or item of test equipment involved.

When the certification self-terminating clock countdown or count up of system 100 is complete (e.g., date that the existing calibration certification expires), processing unit 124 causes power unit 130 to output a current to heating unit 108 (via contacts 116, 118 and 112, 110), which in turn causes a discoloration of a substantial portion of layer 102 and obscures an associated portion of bar code 104. As a failsafe procedure, if desired, system 100 can be implemented to transmit an alert message (e.g., via the transmitter portion of transmitter/receiver unit 136) that indicates the certification has expired. As another failsafe procedure, if desired, processing unit 124 can monitor power unit 130, and if a voltage level of power unit 130 drops to a predetermined value, processing unit 124 can cause power unit 130 to activate heating unit 108 at that time. Thus, in accordance with principles of the present invention, when the calibration certification for that measurement instrument or item of test equipment has expired, the bar code information on layer 102 of system 100 is obscured and cannot be scanned in to generate an equipment list, and a user can see from the discoloration of that layer that the certification has expired. An example of an expired self-terminating certification system, which illustrates an example embodiment of the present invention, is depicted as system 200 in FIG. 2. As such, it may be assumed that system 200 illustrates a version of system 100 in FIG. 1 after an associated calibration certification has expired. As shown, a bar code 204 imprinted on layer 202 has been discolored by a reaction to an increased temperature caused by a heating unit arranged in the label of system 200.

It is important to note that while the present invention has been described in the context of a fully functioning self-terminating certification system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular self-terminating certification system.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A system for indicating the validity of a certification, comprising:
a first layer, said first layer including a certification information part and a termination activation unit arranged substantially adjacent to said certification information part, said certification information part operable to visibly react to an activation of said termination activation unit; and
a second layer, said second layer arranged substantially adjacent to first layer, said second layer including a microcircuit, said microcircuit coupled to said termination activation unit and operable to:
monitor a predetermined time interval;
determine if said predetermined time interval has expired; and
if said predetermined time interval has expired, activate said termination activation unit.

2. The system of claim 1, wherein said system comprises a label.

3. The system of claim 1, wherein said system comprises a calibration label.

4. The system of claim 1, wherein said system comprises a calibration certificate.

5. The system of claim 1, wherein said certification information part comprises at least one of printed bar code, text, encoded text, and alphanumeric code information.

6. The system of claim 1, wherein said first layer and said second layer comprise a single layer of material.

7. The system of claim 1, wherein said termination activation unit comprises a heating element, and said certification information part is formed on a thermally sensitive material.

8. The system of claim 1, wherein said microcircuit includes a processing unit coupled to a power source, said processing unit operable to monitor said predetermined time interval and activate said power source if said predetermined time interval expires.

9. The system of claim 1, wherein the operation to visibly react comprises a changed color state.

10. A self-terminating calibration label, comprising:
an information part formed on a thermally sensitive material, said information part including at least recalibration date information;
a heat conducting part arranged substantially adjacent to said information part;
a timer, said timer operable to determine if a predetermined time interval has expired, said predetermined time interval associated with said at least recalibration date information; and
means for coupling a current to said heat conducting part, if said predetermined time interval has expired.

11. The self-terminating calibration label of claim 10, wherein said information part comprises a bar code printed on a paper material.

12. The self-terminating calibration label of claim 10, wherein said heat conducting part comprises a heating element.

13. The self-terminating calibration label of claim 10, wherein said heat conducting part comprises a Nichrome wire material.

14. The self-terminating calibration label of claim 10, wherein said thermally sensitive material changes color responsive to coupling said current to said heat conducting part if said predetermined time interval has expired.

15. A method for indicating the validity of a certification, comprising the steps of:
forming a layer of material including a certification information part;
arranging a termination activation unit substantially adjacent to said certification information part;
monitoring a predetermined time interval;
determining if said predetermined time interval has expired;
activating said termination activation unit if said predetermined time interval has expired; and
said certification information part visibly reacting to the activating step if said predetermined time interval has expired.

16. The method of claim 15, wherein the reacting step comprises a color change.

17. The method of claim 15, wherein the reacting step comprises a color change from substantially white to substantially black.

18. The method of claim 15, wherein the monitoring, determining and activating steps are performed by a microprocessor.

19. The method of claim 15, wherein said certification information part comprises at least one of printed bar code, text, encoded text, and alphanumeric code information.

20. The method of claim 15, wherein said layer of material comprises a certification label.
